(19) United States
(12) Patent Application Publication
(10) Pub. No.: US 2013/0119959 A1
(43) Pub. Date: May 16, 2013

(54) VOLTAGE ADJUSTING DEVICE FOR SOLID STATE DRIVE

(71) Applicants: YUN BAI, Shenzhen City (CN); QI-YAN LUO, Shenzhen City (CN); SONG-LIN TONG, Shenzhen City (CN)

(72) Inventors: YUN BAI, Shenzhen City (CN); QI-YAN LUO, Shenzhen City (CN); SONG-LIN TONG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/600,221

(22) Filed: Aug. 31, 2012

(30) Foreign Application Priority Data
Nov. 14, 2011 (CN) 201110359167.3

(51) Int. Cl. G05F 5/00

(52) U.S. Cl. 323/299

(57) ABSTRACT

A voltage regulating device includes a connector, a slot, a voltage regulating circuit, and a control module. The connector is obtains an initial voltage from an external power supply. The slot is configured for electrically connecting to a load. The voltage regulating circuit is connected between the connector and the slot. In accordance with user input into a keyboard connected to a control microchip as to a voltage level required, the voltage regulating circuit converts the initial voltage to a required test voltage and outputs the required test voltage to the load by the slot. The control microchip controls the voltage regulating circuit to convert the initial voltage into the required test voltage.

### BACKGROUND

1. Technical Field

The disclosure generally relates to voltage adjusting devices, and particularly to a voltage adjusting device used to provide test voltages for a solid state drive (SSD).

2. Description of Related Art

An SSD is commonly installed in computers by inserting into a small outline dual in-line memory module (SO-DIMM) slot defined in a main board of the computers, where the SSD obtains a voltage from the slot. The slot may be a SO-DIMM double data rate two (DDR2) type or SO-DIMM Double Data Rate three (DDR3) type. The

SSD may be a DDR2 standard or DDR3 standard corresponding to the SO-DIMM DDR2 type or SO-DIMM DDR3 type slot.

During manufacture, a test voltage variable relative to a rated working voltage of the SSD within a preset range is provided to the SSD to test performance stability of the SSD. For example, for a DDR2 standard SSD having a rated working voltage of about 1.5V, the test voltage of about 1.3V-1.7V can be provided to the SSD, to test whether the SSD can work normally and determine the performance stability of the SSD.

However, since the main board may not be able to provide a greater test voltage to the SSD, an external power supply is electrically connected to the SSD to provide the test voltage. To obtain a different test voltage, a different power supply is needed to provide additional power to the SSD, which is inconvenient for users to operate.

Therefore, there is room for improvement within the art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the disclosure.

FIG. 1 is a block diagram of a voltage adjusting device used to provide a test voltage to a load, according to an exemplary embodiment of the disclosure.

FIG. 2 is a partial circuit diagram of the voltage adjusting device in FIG. 1, according to an exemplary embodiment of the disclosure.

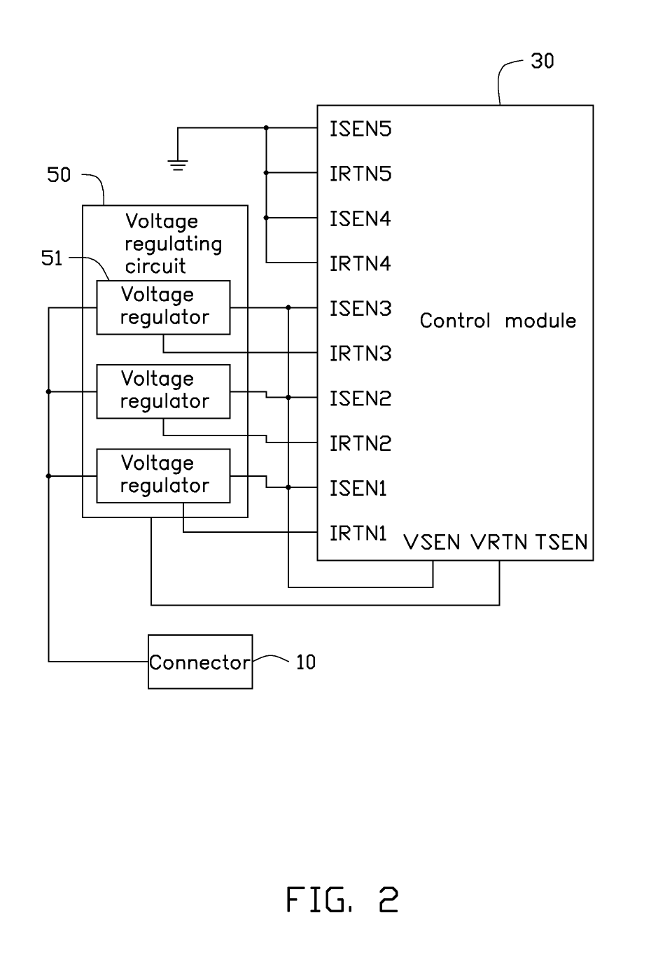

### DETAILED DESCRIPTION

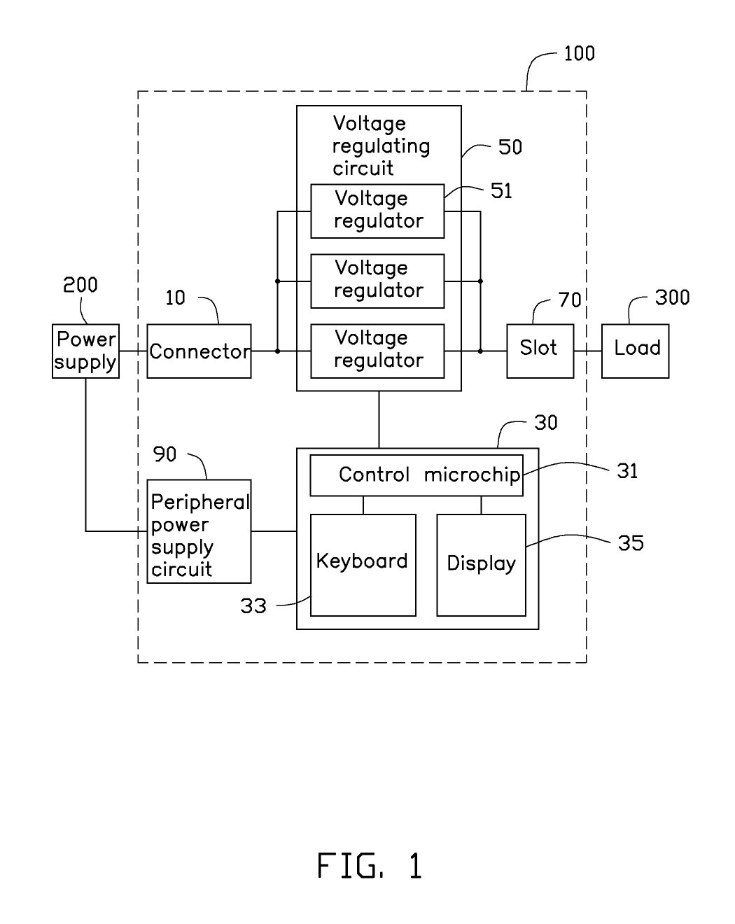

FIG. 1 is a block diagram of a voltage adjusting device 100 used to provide a test voltage to a load 300, according to an exemplary embodiment of the disclosure. In one embodiment, the voltage adjusting device 100 is electrically connected to an external power supply 200 and receives an initial voltage of about 12V from the power supply 200. The load 300 may be a solid state drive (SSD) which requires different test voltages according to different standards of the SSDs. For example, a DDR2 standard SSD has a rated working voltage of about 1.5V, and requires a test voltage of about 1.3V-1.7V. A DDR3 standard SSD has a rated working voltage of about 1.8V, and requires a test voltage of about 1.6V-2.0V.

The voltage adjusting device 100 includes a connector 10, a control module 30, a voltage regulating circuit 50, and a slot 70. The connector 10, the voltage regulating circuit 50 and the slot 70 are electrically connected in series, and connected between the power supply 200 and the load 200. The control module 30 is electrically connected to the power supply 200 and the voltage regulating circuit 50.

The connector 10 connects the power supply 200 to voltage regulating circuit 50. The connector 10 obtains the initial voltage from the power supply 200 and transmits the initial voltage to the voltage regulating circuit 50.

The voltage regulating circuit 50 includes a plurality of voltage regulators 51 connected in parallel. The voltage regulator 51 converts the initial voltage from the power supply 200 into the required test voltage and outputs the required test voltage to the load 300 through the slot 70 under the control of the control module 30. Each voltage regulator 51 has a structure and a performance substantially similar and outputs the same voltage and the same current as the other voltage regulators 51. The voltage regulators 51 are connected in parallel in order to provide a large current to the load 300.

The slot 70 may be a SO-DIMM slot defined in a main board. The load 300 can be inserted into the slot 70 and electrically connected to the slot 70. Thus, the load 300 obtains the required test voltage from the slot 70.

The control module 30 includes a keyboard 33, a control microchip 31, and a display 35. The keyboard 33 and the display 35 are electrically connected to the control microchip 31. The keyboard 33 is configured for a user to input the test voltage which is required by the load 300 according the standard of the load 300 and transmit the required test voltage to the control microchip 31. The control microchip 31 receives the input from the keyboard 33 and controls the voltage regulators 51 to convert the initial voltage into the required test voltage.

In one exemplary embodiment, the control microchip 31 is a CHL8325 type digital integrated circuit. The control microchip 31 further includes a plurality of current detecting contacts ISEN1-ISEN5, a plurality of current feedback contacts IRTN1-IRTN5 corresponding to the current detecting contacts ISEN1-ISEN5, a voltage detecting contact VSEN, a voltage feedback contact VRTN and a temperature detecting contact TSEN. The detecting contacts ISEN1-ISEN5 and the feedback contacts IRTN1-IRTN5 cooperatively detect current output from the voltage regulating circuit 50. The detecting contact VSEN and the feedback contact VRTN cooperatively detect voltage output from the voltage regulating circuit 50. The control microchip 31 calculates power output from the voltage regulating circuit 50 (i.e. power consumed by the load 30), according to the detected current and voltage. The required voltage, the detected current, the detected voltage, and the calculated power can be displayed by the display 35.

A plurality of overcurrent protection thresholds can be preset for the detecting contacts ISEN1-ISEN5. When the detected current exceeds the overcurrent protection threshold, the control microchip 31 executes a protection program (e.g., computerized code) such as controlling the voltage regulator 50 to stop outputting the required voltage.

The power supply device 100 further includes a peripheral power supply circuit 90 connected between the power supply 200 and the control microchip 31. The peripheral power supply circuit 90 converts the initial voltage to a working voltage for the control microchip 31.

When the voltage adjusting device 100 adjusts the initial voltage provided from the power supply 200 to the load 300, the connector 10 is electrically connected to the power supply 200, and the load 300 is inserted into the slot 70. A required test voltage is input to the control microchip 31 by the user on the keyboard 33. The control microchip 31 receives the input and controls the voltage regulators 50 to convert the initial voltage to the required test voltage. The load 30 can obtains the required test voltage from the slot 70 and undergo a test process.

The voltage adjusting device 100 provides required test voltages to the load by allowing the level of test voltage which is required to be set via the keyboard 35 which provides significantly more convenience for the user to stipulate different test voltages for different loads 300.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A voltage regulating device, comprising:
a connector obtaining an initial voltage from an external power supply;
a slot configured for electrically connecting to a load;
a voltage regulating circuit connected between the connector and the slot, the voltage regulating circuit converting the initial voltage into a required test voltage and outputting the required test voltage to the load by the slot; and
a control module, the control module comprising a keyboard and a control microchip electrically connected to the keyboard and the voltage regulating circuit, the keyboard configured for user-input of the required test voltage, and the control microchip controlling the voltage regulating circuit to convert the initial voltage into the required test voltage.

2. The voltage regulating device of claim 1, wherein the voltage regulating circuit comprises a plurality of voltage regulators electrically connected in parallel, each voltage regulator outputs the required test voltage and same current to the load.

3. The voltage regulating device of claim 2, wherein the control microchip presets a plurality of over current protection thresholds corresponding to the voltage regulators, the control microchip detects the current output from each voltage regulator and executes a protection program when the detected current exceeds the corresponding over current protection threshold.

4. The voltage regulating device of claim 3, wherein the control microchip detects the voltage output from each voltage regulator, and calculates power output from the voltage regulating circuit according to the detected current and voltage, the control module further comprises a display, the control microchip controls the display to display the detected current, the detected voltage and the calculated power.

5. The voltage regulating device of claim 1, further comprising a peripheral power supply circuit electrically connected between the external power supply and the control microchip, wherein the peripheral power supply circuit converts the initial voltage into a working voltage for the control microchip.

6. The voltage regulating device of claim 1, wherein the slot is a small outline dual in line memory module slot.
